(19) United States
(12) Patent Application Publication
(10) Pub. No.: US 2025/0327332 A1
(43) Pub. Date: Oct. 23, 2025

(54) AUTOMATIC OPENING DEVICE

(71) Applicant: Elbi International S.p.A., Torino (IT)

(72) Inventor: Fabrizio PROMUTICO, Torino (IT)

(73) Assignee: Elbi International S.p.A., Torino (IT)

(21) Appl. No.: 19/181,390

(22) Filed: Apr. 17, 2025

(30) Foreign Application Priority Data
Apr. 18, 2024 (IT) 102024000008905

(51) Int. Cl. E05B 17/00; E05B 47/00; E05B 65/00; F16H 1/16; F16H 19/00

(52) U.S. Cl. CPC E05B 17/0029; E05B 47/0012; E05B 65/006; F16H 1/16; F16H 19/001; E05B 2047/002

(57) ABSTRACT

The present invention concerns an automatic opening device (1) of a door, such as a door of household appliances, such as washing machines, dishwashers, ovens, and the like, comprising a containment casing (11), an electric motor (3), capable of rotating in the direction of rotation or in the opposite direction of rotation, an actuator member (2), having a rack (21), and a transmission assembly (4), coupled to said electric motor (3) and engaged with said rack (21) of said actuator member (2).

### RELATED APPLICATION

This application claims the benefit of priority of Italy Patent Application No. 102024000008905 filed on Apr. 18, 2024, the contents of which are incorporated by reference as if fully set forth herein in their entirety.

### FIELD AND BACKGROUND OF THE INVENTION

The present invention concerns an automatic opening device.

In more detail, the invention concerns an automatic opening device for a door designed and created in particular for washing machines, dishwashers, and the like, but which can be used for any technical need that requires an automatic closing and opening system, with a safety system.

In the following the description will be directed to opening a door of a household appliance such as a dishwasher, but it is clear that it should not be considered limited to this specific use.

As is currently well known, automatic door opening systems in household appliances, such as dishwashers, washing machines, dryers and ovens, meet the growing needs of manufacturers and consumers for functionality and energy saving. These systems allow, for example in dishwashers, not only faster drying of the dishes thanks to the release of hot steam after washing, but they also prevent the formation of halos due to condensation of the steam on the dishes. Similarly, in washing machines, the automatic opening of the door at the end of the wash cycle prevents the clothes from remaining damp. This is a particularly significant inconvenience when the user is not present to immediately remove the laundry.

Despite their undoubted usefulness, current technical solutions present several problems.

Existing automatic opening mechanisms are often driven by DC motors or solenoids which, although effective in managing the actuation sequence, require complex positional feedback systems via appropriate (and expensive) sensors.

This requirement increases the complexity of the system, the risk of failure and the physical bulk inside the household appliance, thus limiting the space available for other components or for the load capacity of the appliance itself.

Furthermore, although it is preferable for the operating mechanism to be irreversible, to ensure that the door remains in the desired open position, this feature should not, generally, preclude the possibility of manually releasing the system in the event of an emergency, such as a power failure. This controlled reversibility requirement is often not integrated into current mechanisms or is implemented in a manner that compromises their reliability or ease of use.

Therefore, while existing implementations satisfy the fundamental need to automatically open the door, they introduce a number of technical complications that can limit the functionality, reliability and overall usability of the system.

In the field of household appliance design, the challenge of optimizing the use of space is a very important aspect, as market demand is oriented towards components with increasingly smaller dimensions that keep performance unchanged.

The solutions according to the known art, while addressing the need for an automatic opening function, are faced with significant limits in terms of size and space efficiency.

Currently, devices with fewer components and with layouts that maximize the useful space inside the appliance are required.

The problems associated with the prior art are therefore multiple. The first is the physical bulk of the automatic opening mechanisms, which often translates into a reduction in the space available for the appliance's load, a particularly critical aspect for equipment such as dishwashers and washing machines where the internal volume is a primary evaluation parameter for the consumer.

Secondly, the reduction in the number of components is essential not only for space optimization, but also for a reduction in production costs and a lower environmental impact, considering the complete life cycle of the product.

A further problem of the solutions according to the known art is the issue of the noise of the opening mechanisms.

An actuation device that operates silently is also an increasingly pressing request from the market, which seeks to improve the user experience by reducing acoustic disturbance in domestic environments.

Current configurations, often based on DC motors or solenoids, can generate a significant level of noise during the opening and closing action of the door, making the appliance less desirable to the end user.

### SUMMARY OF THE INVENTION

In light of the above, it is therefore the aim of the present invention to overcome the problems related to size, complexity, costs, environmental impact and noise generated by automatic opening systems according to the known art.

It is also the purpose of the present invention to reduce the size of the automatic opening mechanisms inside household appliances to maximize the available internal volume, thus offering consumers equipment with greater load capacity without compromising the external dimensions.

A further purpose of the present invention is to propose an opening system that reduces the total number of mechanical and electrical components involved, thus simplifying the overall layout of the household appliance and reducing potential points of failure.

Finally, the aim of the present invention is to propose an automatic opening system that works silently, to improve the comfort of domestic environments, significantly reducing the noise produced during the operation of the household appliance.

It is, therefore, specific object of the present invention an automatic opening device of a door, such as a door of household appliances, such as washing machines, dishwashers, ovens, and the like, comprising a containment casing, an electric motor, capable of rotating in the direction of rotation or in the opposite direction of rotation, an actuator member, having a rack, and a transmission assembly, coupled to said electric motor and engaged with said rack of said actuator member, wherein, following the operation of said electric motor in one direction of rotation or in the opposite direction of rotation, said actuator member is movable from a retracted position, wherein said actuator member is at least partially inserted into said containment casing, and at least one extracted position, wherein said actuator member extracted from said containment casing, characterized in that said transmission assembly comprises a first reducer engaged with the rack of said actuator member, a second reducer, engaged with said first reducer, a first worm screw, engaged with said second reducer, and a second worm screw, engaged with said first worm screw and keyed to said electric motor,

Always according to the invention, said transmission assembly may be configured to prevent said actuator member, which is in said extracted or retracted position, from passing, in case of stress, respectively to said retracted or extracted position.

Still according to the invention, said first reducer may comprise a first toothed wheel, engaged with said rack, and a second toothed wheel, coaxial and integrated with said first toothed wheel, engaged with said second reducer, wherein said second toothed wheel has a larger diameter than said first toothed wheel.

Advantageously according to the invention, said second reducer may comprise a third toothed wheel, engaged with said first reducer, and a fourth toothed wheel, coaxial and integrated with said third toothed wheel, engaged with said first worm screw, wherein said fourth toothed wheel has a larger diameter than said third toothed wheel.

Further according to the invention, said third toothed wheel may be of the straight tooth type.

Always according to the invention, said actuator member may have a longitudinal slot, and said automatic opening device may comprise a pair of microswitches, arranged so as to detect the extracted or retracted position of said actuator member, a pin, fixed to the containment casing, a lever, a peg arranged on said lever slidably engaged on said longitudinal slot, wherein said lever is capable of assuming the two activation positions of said corresponding microswitches when said actuator member is extracted or retracted.

Still according to the invention, said device may comprise a safety mechanism, for the disengagement of said transmission assembly from said electric motor in case of effort of said electric motor or in case of stress on said actuator member beyond a predefinable threshold if it were forced to move from said extracted position to said retracted position and vice versa.

Advantageously according to the invention, said safety mechanism may comprise a movable frame, a spring, arranged between said movable frame and said containment casing, and a guide, on which said movable frame can be slidably moved, wherein, when the torque exerted by said electric motor exceeds a predefinable threshold, said second reducer rotates on said first worm screw, causing said movable frame to slide on said guide and allowing the disengagement of said transmission assembly from said electric motor.

Further according to the invention, said guide may be parallel to said first worm screw.

Preferably according to the invention, said guide may be obtained on said containment casing or is applied and fixed to said containment casing.

Always according to the invention, said first reducer may be pivoted for rotation on a pin, and said movable frame may be coupled to said pin.

### BRIEF DESCRIPTION OF THE SEVERAL VIEWS OF THE DRAWINGS

The present invention will be now described, for illustrative but not limitative purposes, according to its preferred embodiments, with particular reference to the figures of the enclosed drawings, wherein:

FIG. 1 shows a longitudinal section of an automatic opening device according to the present invention;

FIG. 2 shows a transmission assembly of the automatic opening device of FIG. 1;

FIG. 3 shows a portion of the transmission assembly of FIG. 2;

FIG. 4 shows a sectional view of a safety mechanism 6 of the automatic opening device according to the present invention; and

FIG. 5 shows a detail of the transmission assembly of FIG. 2.

### DESCRIPTION OF SPECIFIC EMBODIMENTS OF THE INVENTION

In the various figures the similar parts will be indicated with the same numerical references.

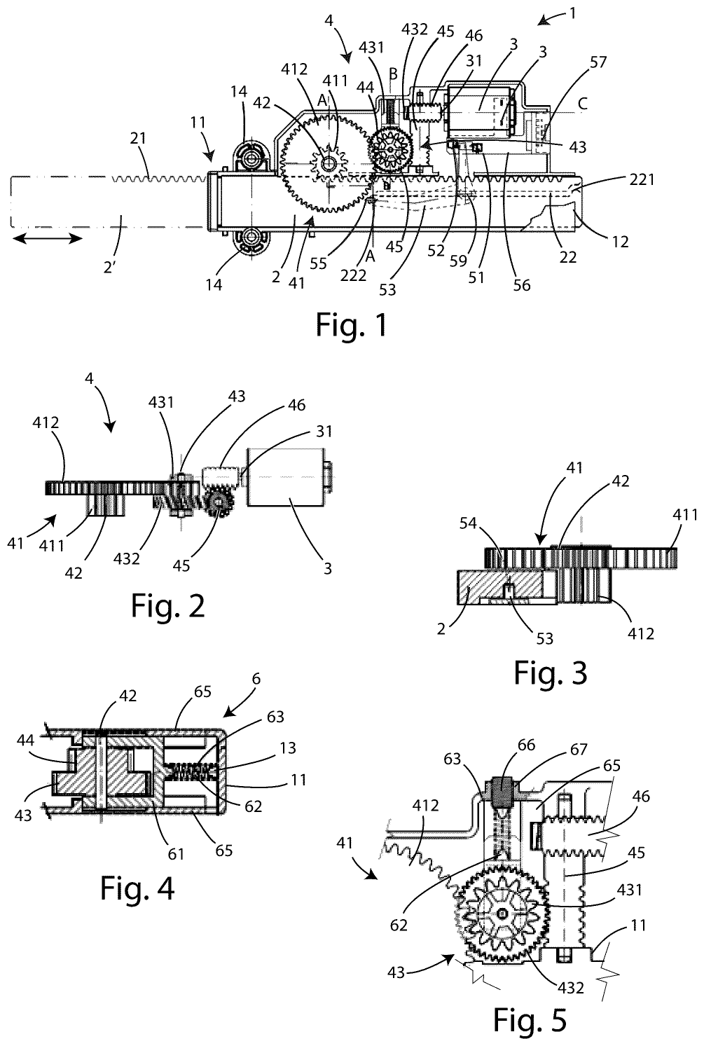

Referring to FIG. 1, an automatic opening device 1 according to the present invention can be seen.

The automatic opening device 1 comprises a containment casing 11, capable of accommodating all the components of the automatic opening device 1. The containment casing 11 allows the complete automatic opening device 1 to be fixed to the household appliance using holes 14 intended to accommodate threaded screws (not shown in the figures), and to be coupled with the corresponding closing cover 12.

The automatic opening device 1 comprises an actuator member 2, having a rack 21. The actuator member 2 is arranged inside the containment casing 11. Said actuator member 2 can slide to act as an ejector up to the extracted position 2′.

Furthermore, said actuator member 2 comprises a longitudinal slot 22, which operation will be better clarified below.

The automatic opening device 1 comprises an electric motor 3, which includes a shaft 31. Furthermore, the electric motor 3 comprises a pair of integrated connection terminals 32, the operation of which will be better explained below.

Furthermore, the automatic opening device 1 also comprises a transmission assembly 4, comprising a first reducer 41 pivoted for rotating around the pin 42 fixed to the containment casing 11. The first reducer comprises a first toothed wheel 411, engaged with the rack 21 of said actuator member 2.

The first reducer 41 also comprises a second toothed wheel 412, coaxial and integrated with the first toothed wheel 411. Said second toothed wheel 412 has a larger diameter than said first toothed wheel 411.

The transmission assembly 4 also comprises a second reduction gear 43, having a third toothed wheel 431, in the present embodiment, of the straight tooth type, engaged with said second toothed wheel 422 of said first reduction gear 41.

Furthermore, said second reducer 43 comprises a fourth toothed wheel 432 with a larger diameter than said third toothed wheel 431.

Also referring to FIGS. 2, 3, and 4, it is observed that the third and fourth toothed wheels 431 and 432 of said second reducer 43 rotate on the pin 44, fixed to the containment casing 11.

The third toothed wheel 4311 is of the helical type.

The transmission assembly 4 comprises a first worm screw 45, engaged with said fourth toothed wheel 432, and a second worm screw 46, engaged with said first worm screw 45 and keyed to the shaft 31 of the electric motor 3. Said first worm screw 45 is, in one embodiment, of the helical type.

In a further embodiment the first 45 and the second 46 worm screws can be made as a single element.

The transmission assembly 4 is designed to be irreversible in motion, i.e. when the actuator member 2 is for example in the extracted position 2′, the mechanism of the transmission assembly 4 prevents its retraction in the event of even a stress on the actuator member 2 itself, which forces it to move from said extracted position to said retracted position. This functional feature allows the positions that the actuator 2 assumes to be maintained stable (extracted, as shown in FIG. 1, or retracted), without the aid of additional locking systems.

The automatic opening device 1 comprises a pair of microswitches 51 and 52, arranged so as to detect the position (extracted or retracted) of the actuator member 2. In particular, the second switch 52 becomes active (closed) when the actuator member 2 is in the retracted position, or inserted inside the containment casing 11; while it is the first microswitch 51 that is active when the actuator member 2 is fully extracted as shown in FIG. 1 (position shown with the dotted line).

For the activation of the aforementioned microswitches 51 and 52, a lever 53 is provided, pivoted on the pin 54, in turn fixed to the containment casing 11, and placed under the actuator member 2, as can be seen in the section of FIG. 3.

The lever 53 comprises a pin 55 (see FIG. 1), which is able to remain coupled or engaged with said longitudinal slot 22 of the actuator member 2. The longitudinal slot 22, together with the ends 221 and 222, acts as a cam or rectilinear guide engaged with said pin 55, and allows the lever 53 to assume the two activation positions of the corresponding signal microswitches 51 and 52 when the member actuator 2 is extended or retracted, as described.

The signals of the microswitches 51 and 52 are transferred through a printed circuit 56 to the connector 57; from the same connector 57, the electric motor 3 is powered again via the printed circuit 56 via said pair of integrated connection terminals 32.

As anticipated, the mechanism of the transmission assembly 4 is irreversible and it is necessary to provide a system capable of forcing the return to the retracted position (by reinserting the actuator member 2 into the containment casing 11), applying a known force from the outside towards the inside of the actuator member 2.

Furthermore, the same system also works in case of overload (or excess) when the transmission assembly 4 encounters an external obstruction and the motor continues to operate, as better explained below.

The automatic opening device 1 is also equipped with a safety mechanism 6. Said safety mechanism 6 is capable of disengaging said transmission assembly 4 from the electric motor 3, in the event of effort by the electric motor 3 or in the event of stress on the actuator member 2, if it were forced to move for example from the extracted position 2′ to the retracted position.

In the present embodiment, said safety mechanism 6 (see in particular FIG. 4) comprises a mobile frame 61, coupled to said pin 42. The mobile frame 61 also comprises a relief 62 and a spring 63, arranged between said relief 62 (and therefore said mobile frame 61) and said containment casing 11.

A positioning relief 13 can also be provided on the internal surface of the containment casing 11 to hold the spring 63 in position.

Finally, the safety mechanism 6 also comprises a guide 65, on which said mobile frame 61 is slidably movable.

In the present embodiment, said guide 65 is obtained on said containment casing 11. In other embodiments, said guide 65 can be applied and fixed to said containment casing 11.

It is observed that said guide is parallel to said first worm screw 45.

In the present embodiment, the first 411 and the second 412 toothed wheels of said first reducer 41 are rotatable on the pin 42, as seen in FIG. 4.

When the torque, proportional to the expected release force, exceeds a certain predefined value at the design level, and the second worm screw 46 is stationary, the fourth toothed wheel 432 will use the second worm 48 as if it were a sort of rack, and will move the mobile frame 61 along the guide 65, compressing the spring 63 until the third toothed wheel 431 and therefore the second reducer are disengaged 43, thus allowing disengagement.

The same operation would occur if the system just described were to operate from overload, i.e., when the electric motor 3 continues to deliver power through the various gears up to the second worm 46, although the second wheel 412 is stopped due to a downstream impediment, i.e. on the actuator member 2. In this case, the spring 63 would be compressed until the teeth of the second toothed wheel 412 and the third toothed wheel 431 are disengaged, and would return to position in the absence of an impediment. The forces at which the mechanism when operating under overload and the forced return must act depends on the preload force of the spring 63, which insists between the internal vertical wall of the containment casing 11 and the mobile frame 61.

In one embodiment (see FIG. 5), the safety mechanism 6 can also comprise a preload screw 66, engaged in a thread 67 obtained on the containment casing 11.

The spring 63 is arranged between the preload screw 66 and the relief 62 arranged on the mobile frame 61.

The resistance force of the spring 63 can thus be easily calibrated as an intervention threshold by means of said preload screw 66, by screwing or unscrewing it from the thread 67.

### Advantages

An advantage of the present invention is that it allows precise opening or closing of a household appliance door, without the need for locking devices.

A further advantage of the present invention is that of providing a decoupling mechanism in case of the opening or closing of the door is forced.

It is also an advantage of the present invention that the device has a reduced complexity of the position feedback system by reducing the number of components.

A further advantage of the present invention is given by the silence of the first reduction pair of the motor via a worm screw with helical teeth which reduces the speed with low noise impact.

The present invention has been described for illustrative but not limitative purposes, according to its preferred embodiments, but it is to be understood that modifications and/or changes can be introduced by those skilled in the art without departing from the relevant scope as defined in the enclosed claims.

1. Automatic opening device of a door, such as a door of household appliances, such as washing machines, dishwashers, ovens, and the like, comprising
a containment casing,
an electric motor, capable of rotating in the direction of rotation or in the opposite direction of rotation,
an actuator member, having a rack, and
a transmission assembly, coupled to said electric motor and engaged with said rack of said actuator member,
wherein, following the operation of said electric motor in one direction of rotation or in the opposite direction of rotation, said actuator member is movable from a retracted position, wherein said actuator member is at least partially inserted into said containment casing, and at least one extracted position, wherein said actuator member extracted from said containment casing,
wherein said transmission assembly comprises
a first reducer engaged with the rack of said actuator member,
a second reducer, engaged with said first reducer,
a first worm screw, engaged with said second reducer, and
a second worm screw, engaged with said first worm screw and keyed to said electric motor.

2. Automatic opening device according to claim 1, wherein said transmission assembly is configured to prevent said actuator member which is in said extracted or retracted position, from passing, in case of stress, respectively to said retracted or extracted position.

3. Automatic opening device according to claim 1, wherein said first reducer comprises
a first toothed wheel, engaged with said rack, and
a second toothed wheel, coaxial and integrated with said first toothed wheel, engaged with said second reducer,
wherein said second toothed wheel has a larger diameter than said first toothed wheel.

4. Automatic opening device according to claim 1, wherein said second reducer comprises
a third toothed wheel, engaged with said first reducer, and
a fourth toothed wheel, coaxial and integrated with said third toothed wheel, engaged with said first worm screw,
wherein said fourth toothed wheel has a larger diameter than said third toothed wheel.

5. Automatic opening device according to claim 1, wherein said third toothed wheel is of the straight tooth type.

6. Automatic opening device according to claim 1, wherein
said actuator member has a longitudinal slot, and
in that said automatic opening device comprises
a pair of microswitches, arranged so as to detect the extracted or retracted position of said actuator member,
a pin, fixed to the containment casing,
a lever,
a peg arranged on said lever slidably engaged on said longitudinal slot,
wherein said lever is capable of assuming the two activation positions of said corresponding microswitches when said actuator member is extracted or retracted.

7. Automatic opening device according to claim 1, further comprising a safety mechanism, for the disengagement of said transmission assembly from said electric motor in case of effort of said electric motor or in case of stress on said actuator member beyond a predefinable threshold if it were forced to move from said extracted position to said retracted position and vice versa.

8. Automatic opening device according to claim 7, wherein said safety mechanism comprises
a movable frame,
a spring, arranged between said movable frame and said containment casing, and
a guide, on which said movable frame can be slidably moved,
wherein, when the torque exerted by said electric motor exceeds a predefinable threshold, said second reducer rotates on said first worm screw, causing said movable frame to slide on said guide and allowing the disengagement of said transmission assembly from said electric motor.

9. Automatic opening device according to claim 8, wherein said guide is parallel to said first worm screw.

10. Automatic opening device according to claim 7, wherein guide is obtained on said containment casing or is applied and fixed to said containment casing.

11. Automatic opening device according to claim 8, wherein
said first reducer is pivoted for rotation on a pin, and
in that said movable frame is coupled to said pin.
